(19) United States
(12) Patent Application Publication
(10) Pub. No.: US 2023/0110834 A1
(43) Pub. Date: Apr. 13, 2023

(54) SYSTEMS AND METHODS FOR PROCESSING OF ONLINE CUSTOMER PRODUCT RETURN REQUESTS

(71) Applicant: Walmart Apollo, LLC, Bentonville, AR (US)

(72) Inventors: Sonney George, Bentonville, AR (US); Olivia G. Lyons, Bentonville, AR (US)

(21) Appl. No.: 17/959,953

(22) Filed: Oct. 4, 2022

Related U.S. Application Data
(60) Provisional application No. 63/251,940, filed on Oct. 4, 2021.

(51) Int. Cl. G06Q 10/08

(52) U.S. Cl. CPC G06Q 10/0837; G06Q 10/0838

(57) ABSTRACT

Systems and methods are provided for processing perishable product return requests submitted by customers to a retailer from which the customers purchased these perishable products. A customer is permitted to submit a perishable product return request via an interface that permits the customer to input one or more reasons for returning the product and upload a photograph of the product. After a customer submits the return request, the system analyzes various product return evaluation factors (including the customer’s trust score, historical product quality data, historical product return attempts by the customer, etc.) in order to determine whether to process the customer’s product return without requiring the customer to return the product in person at a store of the retailer, or whether to require the customer to return the product in person.

### CROSS-REFERENCE TO RELATED APPLICATIONS

This application claims the benefit of U.S. Provisional Application No. 63/251,940, filed Oct. 4, 2021, which is incorporated herein by reference in its entirety.

### TECHNICAL FIELD

This disclosure relates generally to product return requests submitted by customers to a retailer, in particular, to product return requests for perishable products submitted by customers to the retailer.

### BACKGROUND

Typically, to return a product purchased from a store of a retailer that becomes unsatisfactory to the customer after the customer arrives at home, the customer is forced to drive from home back to the store. However, when a customer drives home from a store and finds a low-cost perishable product (e.g., strawberries, bananas, apples, etc.) that is damaged, the customer is more likely to throw the product away instead of taking the time to drive back to the store to return such a low-cost item. One downside for the retailer is that, when the customer is forced to throw away a product that was sold by the retailer to the customer in a damaged/unacceptable condition will cause the customer to be dissatisfied with the retailer and may result in the customer buying less from the retailer or turning to another retailer, which is undesirable for the retailer.

### BRIEF DESCRIPTION OF THE DRAWINGS

Disclosed herein are embodiments of systems and methods pertaining to processing return requests of perishable products submitted online by customers to the retailer from which the customers purchased the products. This description includes drawings, wherein:

FIG. 1 is a diagram of an exemplary system of processing return requests of perishable products submitted online by customers to the retailer from which the customers purchased the products in accordance with some embodiments;

FIG. 2 is a functional diagram of an exemplary return processing server usable with the system of FIG. 1 in accordance with some embodiments;

FIG. 3 is a front view of an exemplary customer electronic device depicting a screen shot of one exemplary product return request submission graphical interface of the system of FIG. 1 in accordance with some embodiments;

FIG. 4 is a front view of an exemplary customer electronic device depicting a screen shot of another exemplary product return request submission graphical interface of the system of FIG. 1 in accordance with some embodiments;

FIG. 5 is a front view of an exemplary customer electronic device depicting a screen shot of another exemplary product return request submission graphical interface of the system of FIG. 1 in accordance with some embodiments;

FIG. 6 is a front view of an exemplary customer electronic device depicting a screen shot of an exemplary product return request submission graphical interface of the system of FIG. 1 in accordance with some embodiments;

FIG. 7 is a front view of customer electronic device depicting a screen shot of an exemplary product return request submission graphical interface of the system of FIG. 1 in accordance with some embodiments;

FIG. 8 is a flow chart diagram of an exemplary process of processing return requests of perishable products submitted online by customers to the retailer from which the customers purchased the products in accordance with some embodiments; and

FIG. 9 is a flow chart diagram of an exemplary process of processing return requests of perishable products submitted online by customers to the retailer from which the customers purchased the products in accordance with some embodiments.

### DETAILED DESCRIPTION

Elements in the figures are illustrated for simplicity and clarity and have not been drawn to scale. For example, the dimensions and/or relative positioning of some of the elements in the figures may be exaggerated relative to other elements to help to improve understanding of various embodiments described herein. Also, common but well-understood elements that are useful or necessary in a commercially feasible embodiment are often not depicted in order to facilitate a less obstructed view of these various embodiments described herein. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment described herein. Thus, appearances of the phrases “in one embodiment,” “in an embodiment,” and similar language throughout this specification may, but do not necessarily, all refer to the same embodiment.

Generally speaking, pursuant to various embodiments, systems and methods are provided for processing perishable product return requests submitted by customers online to a retailer from which the customers purchased these perishable products. A customer is provided with a graphical interface that enables the customer to enter information regarding the perishable product requested to be returned, one or more reasons for requesting to return the product, and/or upload a photograph of the product requested to be returned. After a customer submits the return request via the graphical interface, the system analyzes various factors (e.g., the customer’s trust score, historical product quality data, historical data relating to purchases and returns of this product by this and other customers of the retailer, etc.) in order to determine whether to process the customer’s product return online without requiring the customer to return the product in-person at a store of the retailer, or whether to require the customer to return the product in-person.

In some embodiments, a system of processing online perishable product return requests by customers of a retailer includes an electronic database configured to store data including: a trust score of a customer of the retailer; historical data pertaining to product returns of perishable products previously submitted by the customer and other customers of the retailer; and quality indicators associated with the perishable products offered for sale by the retailer. The system further includes a return processing server including a processor-based control circuit and configured for communication with at least one of a computing device of the customer and the electronic database. The return processing server is configured to receive an online product return request for a perishable product that the customer purchased from the retailer, wherein the online product return request is generated by the customer via an application executable on a computing device of the customer, the application configured to generate a graphical user interface on a display screen of the computing device, the graphical user interface including at least one input field for the customer to provide one or more data inputs, wherein the online product return request comprises one or more data inputs from the customer. The one or more data inputs comprise: a listing of perishable products purchased by the customer from the retailer with a selection of the perishable product purchased by the customer for which to submit the product return request; a graphical element to initiate the product return request for the perishable product selected from the listing; a graphical text element including at least one reason for submitting the product return request for the perishable product selected from the listing; and at least one digital photograph of the perishable product for which the product return request is being submitted. In response to a receipt of the online product return request for the perishable product from the computing device of the customer, the return processing server is configured to: obtain, from the electronic database, the trust score of the customer who submitted the product return request, the historical data pertaining to the product returns of the perishable products previously submitted by the customer, and the quality indicators associated with the perishable product identified in the product return request submitted by the customer; determine, via analysis by the control circuit of the data obtained from the electronic database, whether to approve the product return request submitted by the customer without requiring the customer to bring the product in-person for an inspection at a store of the retailer; and in response to a determination by the control circuit that the product return request submitted by the customer is to be approved, transmit a signal to the electronic database to update the electronic database to: increase the trust score of the customer; and include data indicating that the perishable product return request submitted by the customer has been approved.

In some embodiments, a computer-implemented method of processing online perishable product return requests by customers of a retailer includes: providing an electronic database configured to store data including: a trust score of a customer of the retailer; historical data pertaining to product returns of perishable products previously submitted by the customer and other customers of the retailer; and quality indicators associated with the perishable products offered for sale by the retailer. The method further includes: providing a return processing server including a processor-based control circuit and configured for communication with at least one of a computing device of the customer and the electronic database; receiving, by the return processing server, an online product return request for a perishable product that the customer purchased from the retailer, wherein the online product return request is generated by the customer via an application executable on a computing device of the customer, the application configured to generate a graphical user interface on a display screen of the computing device, the graphical user interface including at least one input field for the customer to provide one or more data inputs, wherein the online product return request comprises one or more data inputs from the customer. The one or more data inputs comprise: a listing of perishable products purchased by the customer from the retailer with a selection of the perishable product purchased by the customer for which to submit the product return request; a graphical element to initiate the product return request for the perishable product selected from the listing; a graphical text element including at least one reason for submitting the product return request for the perishable product selected from the listing; and at least one digital photograph of the perishable product for which the product return request is being submitted. The method further includes, in response to a receipt of the online product return request for the perishable product from the computing device of the customer, by the return processing server: obtaining, from the electronic database, the trust score of the customer who submitted the product return request, the historical data pertaining to the product returns of the perishable products previously submitted by the customer, and the quality indicators associated with the perishable product identified in the product return request submitted by the customer; determining, via analysis by the control circuit of the data obtained from the electronic database, whether to approve the product return request submitted by the customer without requiring the customer to bring the product in-person for an inspection at a store of the retailer; and in response to a determination by the control circuit that the product return request submitted by the customer is to be approved, transmitting a signal to the electronic database to update the electronic database to: increase the trust score of the customer; and include data indicating that the perishable product return request submitted by the customer has been approved.

In yet another embodiment, a system of processing online perishable product return requests by customers of a retailer includes an application executable on a computing device of a customer of the retailer, the application configured to generate, on a display screen of the computing device, a graphical user interface including at least one input field that permits the customer to submit an online product return request for a perishable product that the customer purchased from the retailer. The at least one input field includes: a listing of perishable products purchased by the customer from the retailer, the listing configured to permit the customer to select the perishable product purchased by the customer for which to submit the product return request; a graphical element that permits the customer to initiate the product return request for the perishable product selected from the listing; a graphical text field that permits the customer to enter at least one reason for submitting the product return request for the perishable product selected from the listing; and a graphical element or input field that permits the customer to upload at least one digital photograph of the perishable product for which the product return request is being submitted. The system further includes an electronic database configured to store data including: a trust score of the customer; historical data pertaining to product returns of the perishable products previously submitted by the customer and other customers of the retailer; and quality indicators associated with the perishable products offered for sale by the retailer. The system further includes a return processing server including a processor-based control circuit and configured for communication with at least one of the computing device of the customer and the electronic database, wherein, in response to a receipt of the online product return request for the perishable product from the computing device of the customer. The return processing server is configured to: obtain, from the electronic database, the trust score of the customer who submitted the product return request, the historical data pertaining to the product returns of the perishable products previously submitted by the customer, and the quality indicators associated with the perishable product identified in the product return request submitted by the customer; determine, via analysis by the control circuit of the data obtained from the electronic database, whether to approve the product return request submitted by the customer without requiring the customer to bring the product in-person for an inspection at a store of the retailer; and in response to a determination by the control circuit that the product return request submitted by the customer is to be approved, transmit a signal to the electronic database to update the electronic database to: increase the trust score of the customer; and include data indicating that the perishable product return request submitted by the customer has been approved.

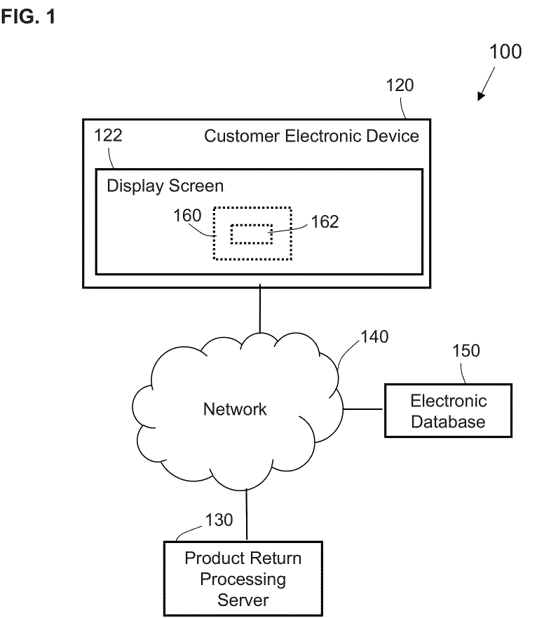

FIG. 1 shows an embodiment of a system 100 for facilitating submission and processing of returns of perishable products submitted online by customers to the retailer from which the customers purchased the products. A retailer will be understood to mean any entity operating as a brick-and-mortar physical store and/or a website accessible, for example, via the internet or another network, by way of which products may be ordered and/or returned by customers. A customer will be understood as an individual or a business entity. Exemplary products that may be purchased by a customer from a retailer may include, but are not limited to, general-purpose consumer goods, as well as consumable products (e.g., food items, medications, dietary supplements, etc.). Exemplary perishable products that may be purchased by a customer from a retailer may include, but are not limited to consumable products associated with a temperature storage requirement and/or consumable products associated with a use by or expiration date after which it is not advisable for the customer to consume the product.

The exemplary system 100 depicted in FIG. 1 includes a return processing server 130, which may be implemented as one computer/server at one facility, or as multiple interconnected computers/servers stored at multiple facilities operated by or for the retailer. In some embodiments, the return processing server 130 is a stationary or portable electronic device, for example, a desktop computer, a laptop computer, a tablet, a mobile phone, or any other electronic device including a processor-based control circuit (i.e., control unit). In the embodiment shown in FIG. 1, the return processing server 130 is configured for data entry and processing as well as for communication with other devices of system 100 via a network 140.

The network 140 may be a wide-area network (WAN), a local area network (LAN), a personal area network (PAN), a wireless local area network (WLAN), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage. In some embodiments, as will be described below and shown in FIG. 1, the return processing server 130 is configured to access at least one electronic database 150 and communicate with electronic devices (e.g., customer electronic device 120) over the network 140 to facilitate the processing of product return requests submitted by customers via customer electronic devices 120.

In the exemplary embodiment illustrated in FIG. 1, the return processing server 130 is communicatively coupled to an electronic database 150 via the network 140. In some embodiments, the electronic database 150 may be configured to store information associated with the product return claims submitted by the customer of the retailer. In some embodiments, the electronic database stores data including, but not limited to: trust score data representing a trust score of each of the customers of the retailer; historical data pertaining to purchases and/or product returns (e.g., time of purchase, price of purchase, etc.) of the perishable products by the customers of the retailer; financial data pertaining to a monetary value of each of the perishable products to the retailer; and quality data representing indicators associated with the perishable products delivered to offered for sale by the retailer. Notably, a trust score of a customer is a numerical representation of the trustworthiness of the customer with respect to online product returns as determined by the return processing server 130 over time by analyzing the customer’s prior online product return requests and data indicating whether the requests were approved or denied.

The electronic database 150 may be stored, for example, on non-volatile storage media (e.g., a hard drive, flash drive, or removable optical disk) internal or external to the return processing server 130, or internal or external to computing devices separate and distinct from the return processing server 130. It will be appreciated that the electronic database 150 may likewise be cloud-based. Notably, while only one electronic database 150 is illustrated by way of example in FIG. 1, the system 100 may include two or more distinct databases accessible by the claim processing server 130 over the network 140.

In the exemplary embodiment illustrated in FIG. 1, a customer of the retailer is permitted to transmit information to and/or access the return processing server 130 over the network 140 via a customer electronic device 120, which may be a stationary, portable, and/or hand-held electronic device, for example, a desktop computer, a laptop computer, a tablet, a mobile phone, or any other electronic, processor-based device configured for data entry and communication with the return processing server 130 over the network 140. In some embodiments, the return processing server 130 is configured to enable customers of the retailer to enter electronic data pertaining to their product return requests by generating an internet-based form (i.e., graphical interface 160) on a display screen 122 of the customer electronic device 120.

In one aspect, this functionality is provided by an application configured to be executed on the customer electronic device 120, which permits the customer electronic device 120 to communicate electronic information indicative of a product return request via the network 140 to the return processing server 130. More specifically, in some embodiments, the graphical interface 160 may be provided by or caused to be displayed by a retailer-associated mobile application (app) installed on the customer electronic device 120 and configured to display various input fields 162, user displays or display portions having menu options, notifications, and/or alerts and notifications for the customer.

In some embodiments, the mobile application is a dedicated application (e.g., an application specific to a retailer and/or specific to the functions described herein). In other embodiments, the application may be a general application that performs the functions described herein but also performs other functions in the operation of the customer electronic device 120. In certain implementations, the application may be an add-on browser application configured to display, on a display screen 122 of the customer electronic device 120, a graphical interface in response to a signal generated by and transmitted to the customer electronic device 120 by the return processing server 130. For example, in some aspects, the graphical interface generated on the display screen 122 of the customer electronic device 120 is an internet-based form having a defined uniform resource locator (URL) address and accessible via an internet browser of the customer electronic device 120.

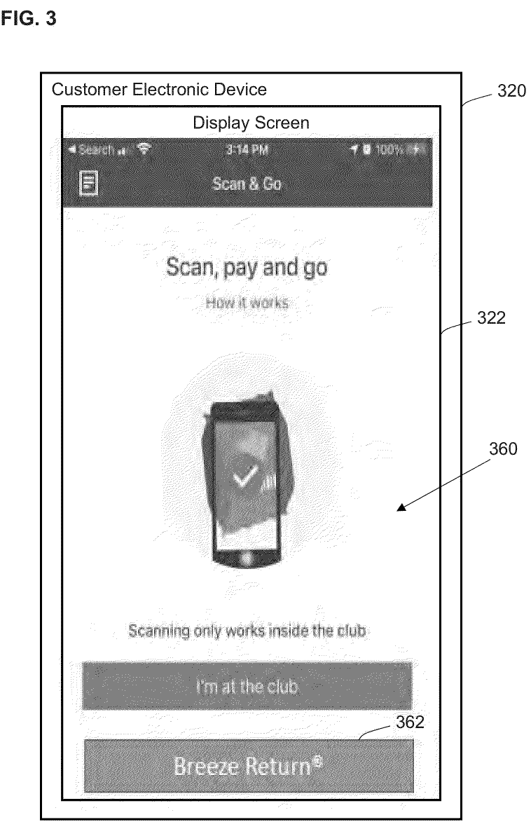

A user interface portion of an exemplary graphical interface 360 that may be generated by or caused to be displayed by an application executable on the customer electronic device 120 to permit the user of the customer electronic device 120 to submit a product return request is illustrated in FIG. 3. As can be seen in FIG. 3, the graphical interface 360 includes an interactive graphical icon 362 that is configured to permit the user of the customer electronic device 120 to initiate an online return for a perishable product that the customer purchased from the retailer. In the embodiment illustrated in FIG. 3, the interactive graphical icon 162 is visibly labeled as “Breeze Return” to make it clear to the customer that interacting with the graphical icon 162 will lead to an initiation of an online product return request.

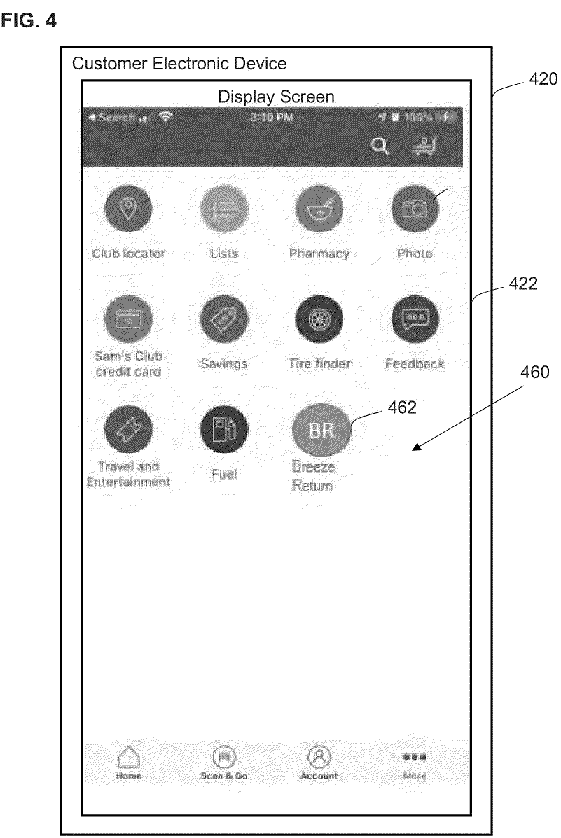

FIG. 4 illustrates another exemplary graphical interface 460 that may be generated by or caused to be displayed by an application executable on the customer electronic device 420 to permit the user of the customer electronic device 420 to submit a product return request. The exemplary graphical interface 460 depicted in FIG. 4 includes, among various interactive graphical icons that provide multiple services (e.g., pharmacy, photo, tire finder, etc.) provided to the customer by the exemplary retailer, an interactive graphical icon 462 that is configured to permit the user of the customer electronic device 420 to initiate an online return for a product that the customer purchased from the retailer. In the embodiment illustrated in FIG. 4, the interactive graphical icon 462 is also visibly labeled as “Breeze Return” to make it clear to the customer that interacting with the graphical icon 462 will lead to an initiation of an online product return request.

In some aspects, as the customer electronic device 120 attempts to connect over the network 140 to the return processing server 130, the return processing server 130 may request a verification of the identity (e.g., username/password) of the user of the customer electronic device 120. The return processing server 130 may then verify the identity of the user of the customer electronic device 120 (e.g., by comparing the username/password data entered by the user of the communication device 140 into the login interface against username/password data associated in the profile of the user stored in the electronic database 150). The return processing server 130 may then associate the verified identity of the user with the stored profile of the user, retrieve the information stored in the profile of the user, and enable the user to connect to and/or log in to the return processing server 130.

With reference back to FIG. 1, in some embodiments, when submitting an online new product return request using the graphical interface 160, the user of the customer electronic device 120 is permitted to initiate the online perishable product return request (i.e., by interacting with the product return graphical icon 162), select a perishable product purchased by the customer that is eligible for an online product return request, and specify various parameters relating to the product return request. With reference now to FIG. 1, an exemplary graphical interface 560 that may be generated on the display screen 522 of the customer electronic device 520 may include a listing indicating the perishable products purchased by the customer that are eligible for an online product return request.

The exemplary graphical interface 560 includes a field 564 that indicates the name of each product, a field 566 indicating a quantity of each product purchased by the customer, a field 568 indicating a per unit price of each product, and a field 569 indicating a total monetary amount associated with the total number of units of each product purchased by the customer. The field 564 may be interactive, such that the customer may select, from the displayed listing of multiple products, a single product (e.g., BANANAS) for which the customer intends to initiate a product request.

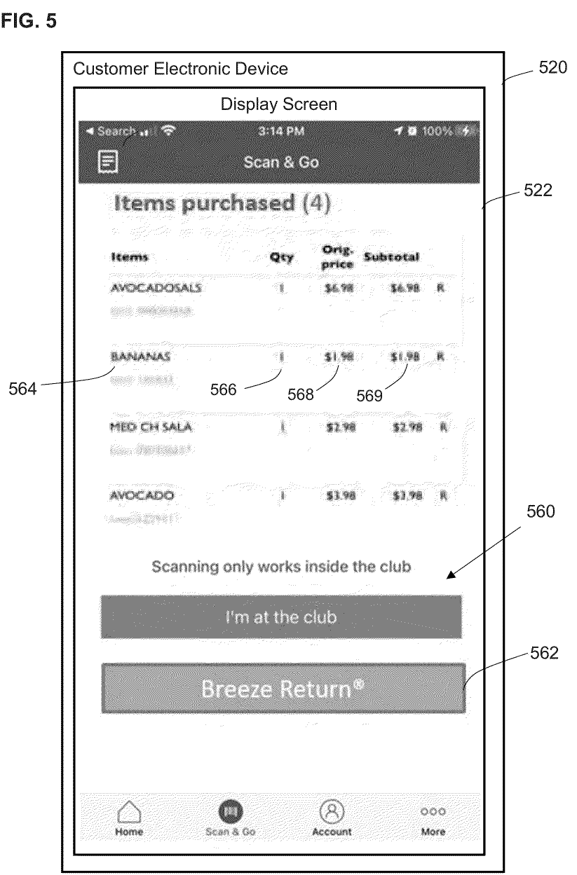

In some embodiments, after the customer interacts with the graphical icon 362 in FIG. 3 or the graphical icon 462 in FIG. 4 to initiate an online product return request, the return processing server 130 obtains (e.g., over the network 140) various data (e.g., historical product purchase history of the customer including a number of units of each product previously purchased by the customer from the retailer, a classification of each product as perishable or non-perishable, a dollar amount of each product previously purchased by the customer, etc.) from the electronic database 150, and processes the data obtained from the electronic database 150 to identify one or more perishable products that were purchased by the customer and are now eligible for an online product return request. In one aspect, after the return processing server 130 identifies the perishable products that are eligible for an online product return request, the return processing server 130 transmits a signal to the customer electronic device 120 that causes the graphical interface 562 displayed on the display screen 522 to be populated with, and display the above-discussed informational fields 564, 566, 568, and 569, as shown in FIG. 5.

In some embodiments, the perishable products that are listed in the graphical interface 562 as being eligible for an online product return represent products, for which the return processing server 130 has determined that the per-unit price of such products does not exceed a predetermined monetary amount threshold that would otherwise make the products ineligible for an online return. In other words, generally speaking, the higher a per unit price of a given product sold by the retailer is, the more likely it is that this product (e.g., jewelry, electronics, furniture, etc.) will be determined by the return processing server 130 to be ineligible for an online product return, and the lower a per-unit price of a given product sold by the retailer is, the more likely it is that this product (e.g., grocery items, fruits, vegetables, etc.) will be determined by the return processing server 130 to be eligible for an online product return.

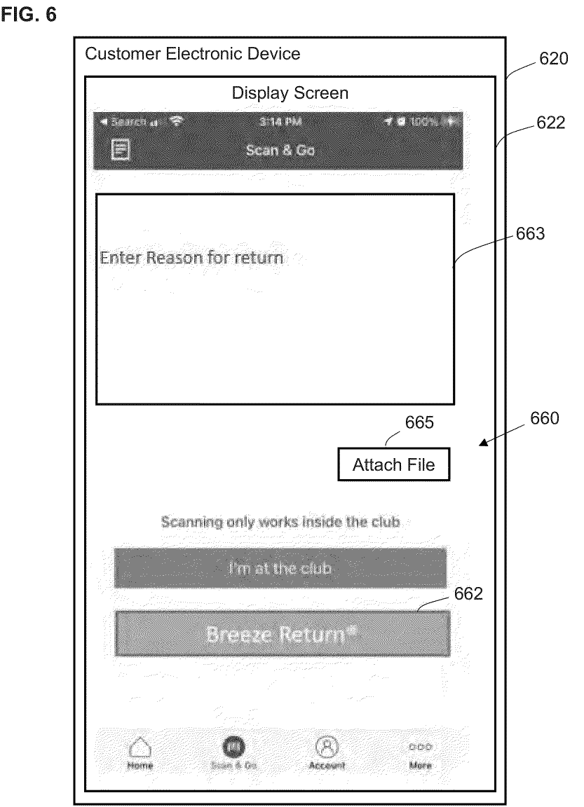

In some embodiments, the interaction of the customer with a field 564 of the graphical interface 562 to select a product for which the customer intends to initiate a product return request causes the exemplary graphical interface 660 as shown in FIG. 6 to be displayed on the display screen 622 of the customer electronic device 620. The exemplary interface 662 includes a text input field 663 that is configured to permit the user of the customer electronic device 620 to input descriptive data (e.g., comments, reasons, etc.) identifying one or more problems with the product giving rise to the online product return request. For example, the descriptive data identifying the problem giving rise to the product return request may that may be input into the field 663 by the customer may include a written description that the product associated with the product return request is: of below standard quality, damaged, and/or or past its expiration (e.g., “use by”) date. The exemplary interface 660 of FIG. 6 further includes a clickable graphical button 665 (i.e., “Attach File”) that enables the customer to upload one or more digital photos of the product being returned to visually illustrate via the photos one or more reasons why the product is being returned by the customer (e.g., due to poor quality, damage, past sell by date, etc.).

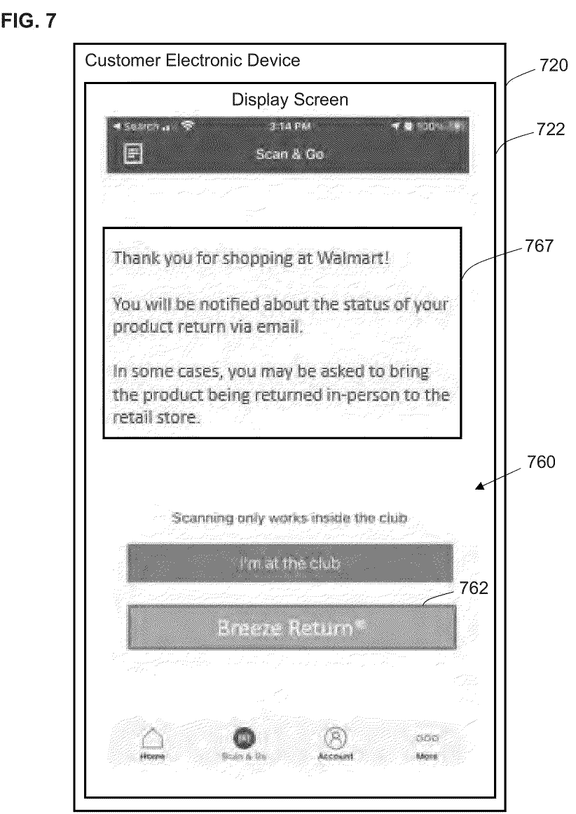

In the illustrated embodiment, after the user of the customer electronic device 520 selects, by interacting with the field 564 of the graphical user interface 562 of FIG. 5, the perishable product for which the product return request is being submitted, adds the comments (i.e., descriptive data) identifying a problem or problems giving rise to the online product return request into the text input field 663 of the graphical user interface 660 of FIG. 6, and uploads, via the clickable graphical button 665 of the graphical user interface 660 of FIG. 6, a photograph visually illustrating one or more issues associated with the product that give rise to the product return request, the return processing server may cause an interface 760 as illustrated in FIG. 7 to be generated for the user on the display screen 722 of the customer electronic device 720.

The exemplary interface 762 of FIG. 7 includes a text field 767 that indicates that the product return request of the customer has been successfully submitted and that the customer will be notified regarding the status of the return request (e.g., via email). In the exemplary embodiment illustrated in FIG. 7, the text field 767 also includes a notification to the customer that, in some cases, the customer may be asked to bring the product being returned in-person to a retail store of the retailer.

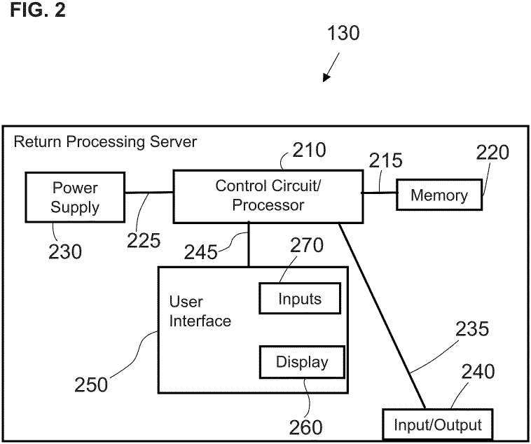

With reference to FIG. 2, an exemplary product return processing server 130 configured for use with the systems and methods described herein may include a programmable control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 of the return processing server 130 can be configured (for example, by using corresponding programming stored in the memory 220 as will be well-understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 210 of the return processing server 130 is also electrically coupled via a connection 235 to an input/output 240 that can receive signals from electronic devices in communication over the network 140 (which may be wired or wireless) with the return processing server 130 (e.g., product request data submitted over the network 140 via the customer electronic device 120, or trust score data, historical purchase/return data, and product quality indicator data obtained by the return processing server 130 from the electronic database 150). The input/output 240 of the return processing server 130 can also send signals to electronic devices in communication over the network 140 with the return processing server 130 (e.g., to send a query for data to the electronic database 150, to and/or to send a notification to the customer electronic device 120 in order to notify the customer as to whether the customer’s product return request will be processed online, or if the customer will be required to physically bring the product in to a retail store of the retailer to process the product return).

In the embodiment shown in FIG. 2, the processor-based control circuit 210 of the return processing server 130 is electrically coupled via a connection 245 to a user interface 250, which may include a visual display or display screen 260 (e.g., LED screen) and/or button input 270 that provide the user interface 250 with the ability to permit an operator of the retailer return processing server 130 to manually control the return processing server 130 by inputting commands via touch-screen and/or button operation and/or voice commands to, for example, to establish a set of business rules governing which products sold by the retailer will be eligible and not eligible for an online product return and/or which customers will be permitted to process their product returns online and which customers will be required to bring the product in for an in-person return at a retail store. It will be appreciated that the performance of such functions by the return processing server 130 of the return processing server 130 is not dependent on a human operator, and that the control circuit 210 may be programmed to perform such functions without a human operator.

In some embodiments, the display screen 260 of the return processing server 130 is configured to display various graphical interface-based menus, options, and/or alerts that may be transmitted to the return processing server 130 and displayed on the display screen 260 in connection with various aspects of the product requests submitted online by customers of the retailer. The inputs 270 of the return processing server 130 may be configured to permit an operator to navigate through the on-screen menus on the return processing server 130 and, for example, mark an online product return request as approved or denied and/or manually to approve or deny a customer’s online product return request and/or send a notification to the customer electronic device 120 to inform the customer as to whether the customer’s online product return request has been approved or denied. It will be appreciated that the display screen 260 may be configured as both a display screen and an input 270 (e.g., a touch-screen that permits an operator to press on the display screen 260 to enter text and/or execute commands.)

As discussed above, in some aspects, the control circuit 210 of the return processing server 130 is programmed to generate one or more graphical interfaces 160, 360, 460, 560, 660, and 760 accessible via the return processing server 130 by the customer electronic devices 120, 320, 420, 520, 620, and 720 over the network 140. As discussed above, the exemplary graphical interfaces 360, 460, 560, 660, and/or 760 are configured (e.g., by including text input fields and/or clickable drop-down menus and/or clickable graphical buttons to permit the user of the customer electronic devices 120, 320, 420, 520, 620, and 720 to submit online product return requests based on one or more reasons for such product return requests.

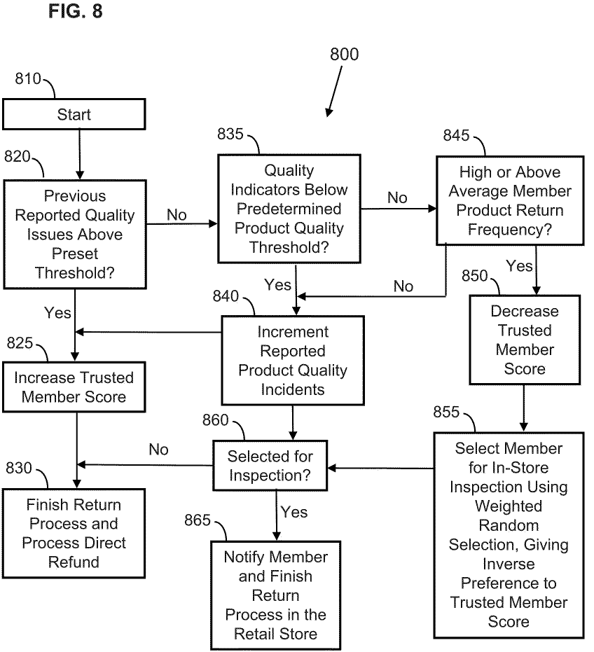

In some embodiments, after a product return request has been submitted by a customer of the retailer using the customer electronic device 120 as described above, the control circuit 210 of the return processing server 130 is programmed to correlate the product return request data submitted via the customer electronic device 120 with various data sets stored in the electronic database 150 in order to determine whether to approve or not approve the online product return request. A flow chart depicting an exemplary logic flow 800 associated with the online product return submission by the customer and the approve/deny determination by the return processing server 130 is illustrated in FIG. 8.

In some embodiments, after an online perishable product return request has been submitted by a user of the customer electronic device 120 as described above, the control circuit 210 of the return processing server 130 is programmed to perform several steps in order to arrive at a decision of whether or not to approve or deny this request, as well as, in some aspects, to process a refund for the returned product to the customer. In the embodiment illustrated in FIG. 8, after an online product return request has been submitted by a user of the customer electronic device 120 (step 810), the control circuit 210 of the return processing server 130 is programmed to determine whether if the previous reported quality issues associated with this product are above a preset threshold (step 820). To this end, the return processing server 130 obtains, from the electronic database 150, historical data indicating a total number of product returns submitted by all customers of the retailer with respect to this product. In some aspects, the return processing server 130 may also obtain, from the electronic database 150, electronic data indicating the trust score of the customer who submitted the product return request.

In the embodiment illustrated in FIG. 8, if the total number of returns for this product exceed a given preset threshold (e.g., 100), i.e., if the answer to the question in Step 820 is “Yes,” then the control circuit 210 is programmed to transmit a signal to the electronic database 150 to cause an update to the trusted member score of the customer that is stored in the electronic database 150 by increasing the trusted member score of the customer (step 825). In other words, if the control circuit 210 of the return processing server 130 determines that more than 100 customers of the retailer previously returned the same product that the current customer is attempting to return, the control circuit 210 is programmed to interpret this finding as an indicator of poor quality issues with the product that makes it more likely than not that the customer currently attempting to return this product online is to be trusted with respect to the less-than-acceptable quality of the product that warrants accepting the customer’s online product return request and increasing the trust score of the customer.

In the exemplary process flow 800 illustrated in FIG. 8, after the control circuit 210 of the return processing server 130 causes the trust score of the customer to be increased in the electronic database 150, the control circuit 210 of the return processing server 130 processes the customer’s online product return and processes a direct refund (or issues store credit) to the customer for the online product return which has been accepted (step 830). In some embodiments, after determining that the customer’s online product return is to be approved, the control circuit 210 of the return processing server 130 is programmed to transmit a signal to the customer electronic device 120 to notify the customer (e.g., via the graphical user interface 160) that the customer’s online product return has been processed, and to transmit a signal to the electronic database 150 to update the electronic database 150 to include data indicating that the product return request submitted by the customer has been approved..

With reference to FIG. 8, if the control circuit 210 of the return processing server 130 determines that the total number of returns for this product does not exceed a given preset threshold (e.g., 100), i.e., if the answer to the question in Step 820 is “No,” then the control circuit 210 of the return processing server 130 is programmed to transmit a signal to the electronic database 150 to obtain electronic data indicative of the quality indicators associated with the product attempted to be returned online by the customer, and to determine whether the quality of the product estimated by the control circuit 210 based on the obtained quality indicators is above or below a predetermined product quality threshold (step 835).

If the control circuit 210 of the return processing server 130 determines that the quality indicators (which may be derived, for example, from a quality control inspection of the product when the product is received by a retail store or distribution center of the retailer) are indicative of a product having a quality that is below a predetermined product quality threshold (e.g., which may relate to physical blemishes on and/or physical damage to the product), i.e., if the answer to the question in Step 835 is “Yes,” then the control circuit 210 is programmed to transmit a signal to the electronic database 150 to increment (i.e., increase) the reported product quality incidents associated with this product (step 840), followed by transmitting a signal to the electronic database 150 to increase the trusted member score of the customer (Step 825). In other words, if the control circuit 210 determines that the reported quality of the product when it was delivered to the retailer is below a certain acceptable product quality threshold, the control circuit 210 is programmed to interpret this finding as an indicator of quality issues with the product that makes it more likely than not that the customer currently attempting to return this product online is to be trusted with respect to the low quality of the product that warrants accepting the customer’s online product return request and increasing the trust score of the customer.

In some embodiments, rather than using quality attributes submitted over time by customers who previously purchased a given perishable product, the quality indicators of this perishable product as a weighted factor are advantageously determined by quality assessment scores determined (based on an inspection of the product) by workers at the distribution centers of the retailer. Such “upstream” quality reports will indicate if a substandard product (e.g., having a score of A- or B) is being shipped, creating a greater risk for a quality concern further in the supply chain (retail store or consumer purchase level). Quality indicators identified from this assessment could factor into the weighted scoring, further validating the trust score of the customer. In certain aspects, product quality issues reported by customers during the product return process will be captured into the electronic database 150. In one aspect, a report threshold is used to alert the retailer of a product quality issue, pointing out a product quality reason code and including an image of the product quality defect, advantageously allowing a retailer to request reimbursement (refund) for this product from the vendor/product supplier who supplied the product to the retailer.

On the other hand, if the control circuit 210 of the return processing server 130 determines that the quality indicators are indicative of a product having a quality determined by a quality control process of the retailer to be above a predetermined product quality threshold, i.e., if the answer to the question in Step 835 is “No,” then the control circuit 210 of the return processing server 130 is programmed to transmit a signal to the electronic database 150 to query the electronic database 150 and obtain historical data reflective of the frequency of returns of products by this customer within a predetermined period of time, which frequency may be expressed as an average obtained by dividing a total number of product returns by this customer within a selected period of time (e.g., 1 week, 1 month, etc.) as compared to product returns submitted by other customers of the retailer (step 845). In some embodiments, step 845 of the method 800 may include the return processing server 130 obtaining from the electronic database 150 historical data reflecting how many times this customer attempted to return products online and how many times the customer’s product returns were accepted and denied, which is also indicative of the trustworthiness of the customer and relates to the trust score of the customer.

If the control circuit 210 of the return processing server 130 determines that the product return frequency of the customer requesting an online product return is below an average product return frequency in comparison to other customers of the retailer, i.e., if the answer to the question in Step 845 is “No,” then the control circuit 210 of the return processing server 130 is programmed to transmit a signal to the electronic database 150 to increment (i.e., increase) the reported product quality incidents associated with this product (step 840), followed by transmitting a signal to the electronic database 150 to increase the trusted member score of the customer (Step 825). In other words, if the control circuit 210 of the return processing server 130 determines that the customer attempting to return a product online does not have a higher rate of product return requests (or a higher rate of denied product return requests) as compared to other customers of the retailer, the control circuit 210 is programmed to interpret this finding as an indicator of quality issues with the product that makes it more likely than not that the customer currently attempting to return this product online is to be trusted with respect to the low quality of the product that warrants accepting the customer’s online product return request and increasing the trust score of the customer.

On the other hand, if the control circuit 210 of the return processing server 130 determines that the product return frequency of the customer requesting an online product return is above an average product return frequency (or has a higher rate of denied product return requests) in comparison to other customers of the retailer, i.e., if the answer to the question in Step 845 is “Yes,” then the control circuit 210 is programmed to transmit a signal to the electronic database 150 to cause an update to the trusted member score of the customer that is stored in the electronic database 150 by decreasing the trusted member score of the customer (step 850). In other words, if the control circuit 210 of the return processing server 130 determines that the customer attempting to return a product online has a higher rate of product returns or a higher than average number of denied product return requests in comparison to other customers of the retailer, the control circuit 210 of the return processing server 130 is programmed to interpret this finding as an indicator that makes it more likely than not that the customer currently attempting to return this product online is not to be trusted with respect to the low quality of the product that would otherwise warrant accepting the customer’s online product return request, and that warrants decreasing the trust score of the customer.

In the exemplary process flow 800 illustrated in FIG. 8, after the control circuit 210 of the return processing server 130 causes the trust score of the customer to be decreased in the electronic database 150, the control circuit 210 of the return processing server 130 is programmed to determine whether or not to still process the customer’s online product return (e.g., to reduce unnecessary additional product return costs for the retailer), or to require the customer to come in for an in-person return of the product at a retail store of the retailer (Step 855). In one aspect, the control circuit 210 is programmed to perform an analysis of whether to select the customer for an in-person product return by utilizing a random weight selection model, giving inverse preference to the trusted member score of the customer. In other words, in some aspects, the control circuit 210 of the return processing server 130 is programmed to randomly determine whether or not to select the customer for an in-person product return by factoring in the customer’s known trusted member score, and adjusting the variables such that it will be less likely that the customer will be randomly selected for an in-person product return if the customer has a higher trusted member score, and more likely that the customer will be randomly selected for an in-person product return if the customer has a lower trusted member score.

If, at step 860, the control circuit 210 of the return processing server 130 determines that the customer is not selected for an in-person inspection and return of the product at a retail store of the retailer, i.e., if the answer to the question in step 860 is “No,” then the control circuit 210 of the return processing server 130 is programmed to process a direct refund (or issue store credit) to the customer for the product the online return for which has been accepted (step 830). As mentioned above, in some aspects, after determining that the customer’s online product return is to be approved, the control circuit 210 of the return processing server 130 is programmed to transmit a signal to the customer electronic device 120 to notify the customer (e.g., via the graphical user interface 160) that the customer’s online product return has been processed and/or to transmit a signal to the electronic database 150 to update the electronic database 150 to include data indicating that the product return request submitted by the customer has been approved.

On the other hand, if, at step 860, the control circuit 210 of the return processing server 130 selects the customer for an in-person inspection and return of the product at a retail store of the retailer, i.e., if the answer to the question in step 860 is “Yes,” then the control circuit 210 of the return processing server 130 is programmed to transmit an electronic notification to the customer electronic device 120 to notify the customer (e.g., via the graphical user interface 160) that the customer’s online product return has been denied and can only be processed in-person at the retail store of the retailer and/or to transmit a signal to the electronic database 150 to update the electronic database 150 to include data indicating that the product return request submitted by the customer has been denied (step 865).

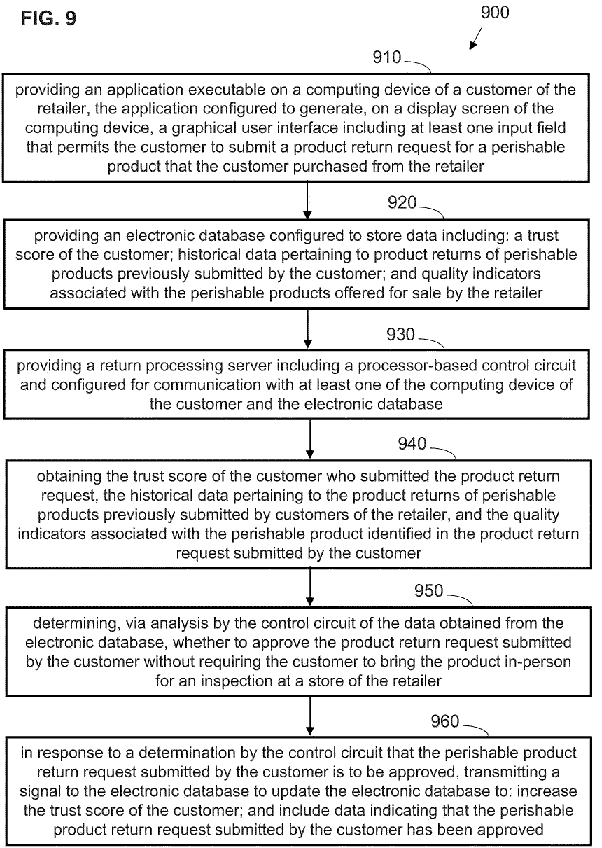

FIG. 9 shows an embodiment of an exemplary computer-implemented method 900 of processing online perishable product return requests submitted by customers of a retailer. The exemplary method 900 includes providing an application executable on a computing device 120 of a customer of the retailer, the application configured to generate, on a display screen 122 of the computing device 120 of the customer, a graphical user interface 160 including at least one input field 162 that permits the customer to submit a product return request for a perishable product that the customer purchased from the retailer (step 910). As discussed in more detail above, the at least one input field 162 may include: a listing of perishable products purchased by the customer from the retailer, the listing configured with interactive fields 564 to permit the customer to select the perishable product purchased by the customer for which to submit the product return request; a graphical element 562 that permits the customer to initiate the product return request for the perishable product selected from the listing; a graphical text field t663 hat permits the customer to enter at least one reason for submitting the product return request for the perishable product selected from the listing; and a graphical element or input field 665 that permits the customer to upload at least one digital photograph of the perishable product for which the product return request is being submitted.

The exemplary method 900 further includes providing an electronic database 150 configured to store data including: a trust score of the customer; historical data pertaining to product returns of perishable products previously submitted by the customer and other customers of the retailer; and quality indicators associated with the perishable products offered for sale by the retailer (step 920). The method 900 further includes providing a return processing server 130 including a processor-based control circuit 210 and configured for communication with at least one of the computing device 120 of the customer and the electronic database 150 (step 930).

The method 900 shown in FIG. 9 includes obtaining by the return processing server 130 from the electronic database 150 in response to receiving the product return request for the perishable product from the computing device 120 of the customer, the trust score of the customer who submitted the product return request, the historical data pertaining to the product returns of perishable products previously submitted by the customer and the other customers of the retailer, and the quality indicators associated with the perishable product identified in the product return request submitted by the customer (step 940). After the return processing server obtains various data from the electronic database 150 that enables the control circuit 210 to process the customer’s online product return request, the method 900 further includes determining, via analysis by the control circuit 210 of the data obtained from the electronic database 150, whether to approve the product return request submitted by the customer without requiring the customer to bring the product in-person for an inspection at a store of the retailer (step 950).

In the illustrated embodiment, in response to a determination by the control circuit 210 of the return processing server 130 that the online product return request submitted by the customer is to be approved, the exemplary method 900 further includes transmitting a signal to the electronic database 150 to update the electronic database 150 to: increase the trust score of the customer; and include data indicating that the perishable product return request submitted by the customer has been approved. In addition, as mentioned above, the method according to some embodiments may include transmitting a signal from the return processing server 130 to the customer electronic device 120 to notify the customer (e.g., via the graphical user interface 160) that the customer’s online product return has been processed and/or that a refund of the monetary amount paid by the customer for the successfully returned product has been/is being processed.

The systems and methods described herein advantageously allow customers of retail stores to easily and conveniently submit product return requests for certain products online without having to deal with the inconvenience of traveling to the retail store in order to return a product. Such systems and methods provide the customers with significant time and cost savings (associated with driving a product to return at the retail store) while simultaneously providing the retailers with significant worker time and operation cost savings (associated with processing in-person product returns), thereby benefitting both customers of the retailer and the retailer.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

What is claimed is:

1. A system of processing online perishable product return requests by customers of a retailer, the system comprising:
an electronic database configured to store data including:
a trust score of a customer of the retailer;
historical data pertaining to product returns of perishable products previously submitted by the customer and other customers of the retailer; and
quality indicators associated with the perishable products offered for sale by the retailer; and
a return processing server including a processor-based control circuit and configured for communication with at least one of a computing device of the customer and the electronic database, wherein the return processing server is configured to:
receive an online product return request for a perishable product that the customer purchased from the retailer, wherein the online product return request is generated by the customer via an application executable on a computing device of the customer, the application configured to generate a graphical user interface on a display screen of the computing device, the graphical user interface including at least one input field for the customer to provide one or more data inputs, wherein the online product return request comprises one or more data inputs from the customer, wherein the one or more data inputs comprise:
a listing of perishable products purchased by the customer from the retailer with a selection of the perishable product purchased by the customer for which to submit the product return request;
a graphical element to initiate the product return request for the perishable product selected from the listing;
a graphical text element including at least one reason for submitting the product return request for the perishable product selected from the listing; and
at least one digital photograph of the perishable product for which the product return request is being submitted;
wherein, in response to a receipt of the online product return request for the perishable product from the computing device of the customer, the return processing server is configured to:
obtain, from the electronic database, the trust score of the customer who submitted the product return request, the historical data pertaining to the product returns of the perishable products previously submitted by the customer, and the quality indicators associated with the perishable product identified in the product return request submitted by the customer;
determine, via analysis by the control circuit of the data obtained from the electronic database, whether to approve the product return request submitted by the customer without requiring the customer to bring the product in-person for an inspection at a store of the retailer; and
in response to a determination by the control circuit that the product return request submitted by the customer is to be approved, transmit a signal to the electronic database to update the electronic database to:
increase the trust score of the customer; and
include data indicating that the perishable product return request submitted by the customer has been approved.

2. The system of claim 1, wherein the graphical user interface permits the customer to submit the product return request via the graphical user interface only if the price of the perishable product for which the customer is attempting to submit the product return request does not exceed a predetermined monetary amount threshold.

3. The system of claim 1, wherein, in response to the determination by the control circuit that the perishable product return submitted by the customer is to be approved, the return processing server is configured to transmit an electronic notification to the computing device of the customer to notify the customer that the product return request of the customer has been successfully processed.

4. The system of claim 3, wherein, in response to the determination by the control circuit that the perishable product return submitted by the customer is to be approved, the return processing server is configured to process a refund to the customer of an amount corresponding to a price of the perishable product for which the product return request has been approved.

5. The system of claim 1, wherein the control circuit of the return processing server is programmed to generate the trust score for the customer via an analysis of a number of the product return requests for the perishable products previously submitted by the customer that were approved and a number of the product return requests for the perishable products previously submitted by the customer that were denied.

6. The system of claim 1, wherein the control circuit of the return processing server is programmed to increase the trust score of the customer in response to a determination by the control circuit of the return processing server that a number of product return requests by other customers for the perishable product that is the subject of the product return request submitted by the customer exceeds a predefined product return threshold.

7. The system of claim 1, wherein the control circuit of the return processing server is programmed to decrease the trust score of the customer in response to a determination by the control circuit of the return processing server that:
a number of product return requests by other customers for the perishable product that is the subject of the product return request by the customer is below a predefined product return threshold;
the quality indicators associated with the perishable product that is the subject of the product return request by the customer are above a predefined product quality threshold; and
a total number of perishable product return requests by the customer over a selected interval of time is above an average number of product return requests by other customers of the retailer.

8. The system of claim 1, wherein, in response to a determination by the control circuit of the return processing server that the perishable product return submitted by the customer is to be denied, the control circuit of the return processing server is programmed to cause the return processing server to transmit a signal to the electronic database to update the electronic database to decrease the trust score of the customer and to include data indicating that the product return request submitted by the customer has been denied.

9. The system of claim 8,
wherein the control circuit of the return processing server is programmed to apply random weighted selection to determine whether the customer whose product return request of the perishable product has been denied is to be selected for an in-person inspection of the perishable product for which the product return request has been denied;
wherein the control circuit is programmed to give the trust score of the customer an inverse preference in the random weighted selection; and
wherein, if the control circuit of the return processing server determines that the customer is to be selected for the in-person inspection perishable product for which the product return request has been denied, the control circuit of the return processing server is programmed to cause the return processing server to transmit an electronic notification to the computing device of the customer to notify the customer that the product return request of the customer can only be processed in-person at a retail store of the retailer.

10. The system of claim 9, wherein, in response to a determination by the control circuit of the return processing server that the customer is not to be selected for the in-person inspection perishable product for which the product return request has been denied, the control circuit of the return processing server is programmed to:
transmit an electronic notification to the computing device of the customer to notify the customer that the product return request of the customer has been processed; and
process a refund to the customer of an amount corresponding to a price of the perishable product for which the perishable product return request has been approved.

11. A computer-implemented method of processing online perishable product return requests by customers of a retailer, the method comprising:
providing an electronic database configured to store data including:
a trust score of a customer of the retailer;
historical data pertaining to product returns of perishable products previously submitted by the customer and other customers of the retailer; and
quality indicators associated with the perishable products offered for sale by the retailer; and
providing a return processing server including a processor-based control circuit and configured for communication with at least one of a computing device of the customer and the electronic database;
receiving, by the return processing server, an online product return request for a perishable product that the customer purchased from the retailer, wherein the online product return request is generated by the customer via an application executable on a computing device of the customer, the application configured to generate a graphical user interface on a display screen of the computing device, the graphical user interface including at least one input field for the customer to provide one or more data inputs, wherein the online product return request comprises one or more data inputs from the customer, wherein the one or more data inputs comprise:
a listing of perishable products purchased by the customer from the retailer with a selection of the perishable product purchased by the customer for which to submit the product return request;
a graphical element to initiate the product return request for the perishable product selected from the listing;
a graphical text element including at least one reason for submitting the product return request for the perishable product selected from the listing; and
at least one digital photograph of the perishable product for which the product return request is being submitted;
in response to a receipt of the online product return request for the perishable product from the computing device of the customer, by the return processing server:
obtaining, from the electronic database, the trust score of the customer who submitted the product return request, the historical data pertaining to the product returns of the perishable products previously submitted by the customer, and the quality indicators associated with the perishable product identified in the product return request submitted by the customer;
determining, via analysis by the control circuit of the data obtained from the electronic database, whether to approve the product return request submitted by the customer without requiring the customer to bring the product in-person for an inspection at a store of the retailer; and
in response to a determination by the control circuit that the product return request submitted by the customer is to be approved, transmitting a signal to the electronic database to update the electronic database to:
increase the trust score of the customer; and
include data indicating that the perishable product return request submitted by the customer has been approved.

12. The method of claim 11, further comprising permitting the customer to submit the product return request via the graphical user interface only if the price of the perishable product for which the customer is attempting to submit the product return request does not exceed a predetermined monetary amount threshold.

13. The method of claim 11, further comprising, in response to the determination by the control circuit that the perishable product return request submitted by the customer is to be approved, transmitting an electronic notification to the computing device of the customer to notify the customer that the product return request of the customer has been successfully processed.

14. The method of claim 13, further comprising, in response to the determination by the control circuit that the perishable product return request submitted by the customer is to be approved, processing a refund to the customer of an amount corresponding to a price of the perishable product for which the product return request has been approved.

15. The method of claim 11, further comprising generating, via the return processing server, the trust score for the customer, wherein the generating of the trust score for the customer comprises analyzing, by the control circuit, a number of the product return requests for the perishable products previously submitted by the customer that were approved and a number of the product return requests for the perishable products previously submitted by the customer that were denied.

16. The method of claim 11, further comprising increasing the trust score of the customer by the control circuit of the return processing server in response to a determination by the control circuit of the return processing server that, a number of product return requests by other customers for the perishable product that is the subject of the product return request submitted by the customer exceeds a predefined product return threshold.

17. The method of claim 11, further comprising decreasing the trust score of the customer by the control circuit of the return processing server in response to a determination by the control circuit of the return processing server that:
a number of product return requests by other customers for the perishable product that is the subject of the product return request by the customer is below a predefined product return threshold;
the quality indicators associated with the perishable product that is the subject of the product return request by the customer are above a predefined product quality threshold; and
a total number of perishable product return requests by the customer over a selected interval of time is above an average number of product return requests by other customers of the retailer.

18. The method of claim 11, further comprising, in response to a determination by the control circuit that the perishable product return submitted by the customer is to be denied, transmitting a signal to the electronic database to update the electronic database to decrease the trust score of the customer and to include data indicating that the product return request submitted by the customer has been denied.

19. The method of claim 18, further comprising:
determining by the control circuit by applying random weighted selection, whether the customer whose product return request of the perishable product has been denied, is to be selected for an in-person inspection of the perishable product for which the product return request has been denied, wherein the control circuit is programmed to give the trust score of the customer an inverse preference in the random weighted selection; and
if the control circuit determines that the customer is to be selected for the in-person inspection perishable product for which the product return request has been denied, transmitting an electronic notification to the computing device of the customer to notify the customer that the product return request of the customer can only be processed in-person at a retail store of the retailer.

20. The method of claim 19, further comprising, if the control circuit determines that the customer is not to be selected for the in-person inspection perishable product for which the product return request has been denied:
transmitting an electronic notification to the computing device of the customer to notify the customer that the product return request of the customer has been processed; and
processing a refund to the customer of an amount corresponding to a price of the perishable product for which the product return request has been approved.
